(19) United States
(12) Patent Application Publication
(10) Pub. No.: US 2026/0300217 A1
(43) Pub. Date: Oct. 1, 2026

(54) HIGH PARALLELISM DPIM

(71) Applicants: BALAJI VIJAYAKUMAR, HORAMAVU (IN); JOHN YU, SAN JOSE, CA (US); KRISHNAMURTHY SUBRAMANIAN, SARATOGA, CA (US)

(72) Inventors: BALAJI VIJAYAKUMAR, HORAMAVU (IN); JOHN YU, SAN JOSE, CA (US); KRISHNAMURTHY SUBRAMANIAN, SARATOGA, CA (US)

(21) Appl. No.: 19/629,063

(22) Filed: Mar. 26, 2026

Related U.S. Application Data
(60) Provisional application No. 63/777,993, filed on Mar. 26, 2025.

(51) Int. Cl. G06F 15/78

(52) U.S. Cl. CPC G06F 15/7821

(57) ABSTRACT

A digital processing-in-memory (DPIM) macro optimizes memory partitioning and compute parallelism. Ahead-of-cycle memory readout with simplified local storage, where the readout is held in a flip-flop for four or eight cycles to enable efficient processing. A pipelined adder tree implemented, with design optimizations to fully utilize the available bit-widths at each stage, ensuring efficient aggregation and processing of input bits. The DPIM efficiently processes 4-bit and 8-bit inputs with 1-bit weights over multiple cycles.

### FIELD OF THE INVENTION

The present disclosure relates to the operation of a digital process-in-memory SRAM design having a pipelined adder tree and ahead-of-cycle weight readout.

### BACKGROUND

Artificial intelligence (AI) applications are typically memory intensive, and are generally implemented with a convolutional neural network (CNN), such as the CNN represented in FIG. 1. For an AI application to operate efficiently, it is necessary to implement a fully connected neural network layer (see FIG. 2), having a comparatively large number of neurons which are comprised of, among other things, a plurality of static random-access memory (SRAM) cells. Further, in order to improve computational efficiency, in-memory computing (IMC) techniques have been designed to limit the movement of data between a compute function and memory. One in-memory computing architecture is a Charge-Domain In-Memory Computing 6T-SRAM (CAP-RAM), such as the one represented in FIG. 3. The design and operation of a CAP-RAM macro is described in a paper published by the IEEE in 2021 under the title “CAP-RAM: A Charge-Domain In-Memory Computing 6T-SRAM for Accurate and Precision-Programmable CNN Inference”.

Generally, each memory cell comprising a cluster can operate to maintain a weight value (either a logical one or zero) that is read-out from the cell prior to a multiply and accumulate (MAC) operation. Subsequently, the weight and an input vector value to the CNN are multiplied and further accumulated during the MAC process to create a point product used by a convolutional neural network for a variety of different reasons.

### BRIEF DESCRIPTION OF THE DRAWINGS

FIG. 1 is a diagram showing functional elements comprising a digital process-in-memory (DPIM) architecture.

FIG. 2 is a diagram illustrating a DPIM 6T-cell cluster 200.

FIG. 3 is a diagram illustrating a plurality of DPIM 6T-cell clusters comprising a slice.

FIG. 4 is a diagram illustrating one embodiment of an adder tree.

FIG. 5 is a diagram illustrating another embodiment of an adder tree.

FIG. 6 is a timing diagram illustrating a DPIM four cycle compute phase.

FIG. 7 is a timing diagram illustrating an ahead-of-cycle weight read-out operation.

FIG. 8 is a timing diagram illustrating a cell cluster pre-charge operation.

FIG. 9 is a diagram illustrating the pre-charge operation.

FIG. 10 is a timing diagram illustrating word-line enable triggering a local read.

FIG. 11 is a diagram illustrating the local read operation in a 6T bit-cell.

FIG. 12 is a timing diagram illustrating a complete timing diagram of a four-cycle compute phase.

### DETAILED DESCRIPTION

Compute in-memory (or process in-memory) macros implemented in a static random-access memory (SRAM) device can operate to process convolutional neural network weight values very efficiently, however certain macro-operations present bottlenecks to the computational process. For example, a local read operation consists of pre-charging a local bit-line (LBL) and then reading out the selected word-line. These steps consume valuable cycle time as they both occur during a compute cycle. Also, adder tree design can result in wasted logic gates that do not fully utilize the adder trees bit capacity. Further, treating an adder tree as a fully combinational functional block can increase critical path delays, leading to longer compute cycle time.

In order to overcome the above problems, we have designed a new digital processing-in-memory (DPIM) macro architecture that implements memory partitioning and compute parallelism, along with ahead of compute cycle weight read out, and a pipelined adder tree design that fully utilizes each adder stage.

The DPIM macro is comprised of sixty-four slices of 6T bit-cell clusters that are partitioned into sixteen groups of four slices each. Each slice has one hundred twenty-eight 6T bit-cell clusters, and each cluster has eight 6T bit-cells.

According to one embodiment, during a compute operation, an input vector is streamed into the macro array, and each cluster in each group of four slices performs a parallel MAC (multiply-and-accumulate) operation on a streamed input vector value and stored weight value information.

According to another embodiment, a temporary storage device is controlled to support parallel MAC operations across each grouping of slices comprising the DPIM macro.

According to another embodiment, a D-Flip-Flop comprising each cluster of eight 6T bit-cells operates as a sensing circuit to readout a weight maintained in any one of the bit-cells ahead of a subsequent compute cycle.

According to another embodiment, an adder tree is designed such that the available bit capacity of each of a plurality of stages is fully utilized. A first stage of the adder tree can have a plurality of full-adders and one half-adder; a second stage is also fully utilized and comprises a plurality of two-bit adders. According to this embodiment, full utilization of a stage refers to grouping inputs to each adder in a manner that allows the adder output to span a complete numerical range, from the minimum to the maximum possible value.

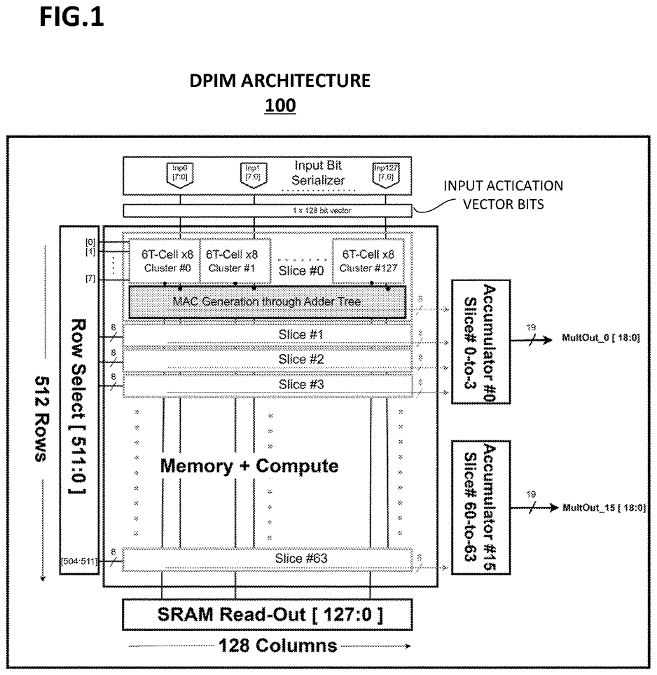

These, and other embodiments, will now be described with reference to the figures, in which FIG. 1 is drawing illustrating a digital processing-in-memory (DPIM) architecture 100 that implements the embodiments as will be described as follows. The DPIM 100 is comprised of sixty-four slices of 6T-cell clusters labeled slice #0 to slice

Each slice is comprised of eight 6T bit-cells and MAC functionality 115 that operates to process weight information, maintained in the cells, and serialized vector information sent to the MAC functionality. As shown in FIG. 1, the sixty-four slices are divided into groupings of four slices each, and the Row Select functionality operates to determine which slices and which 6T cell in a cluster participate in a MAC operation during a particular clock cycle. A bit-cell position selected in all clusters in a slice and for all slices remains the same during a particular clock cycle.

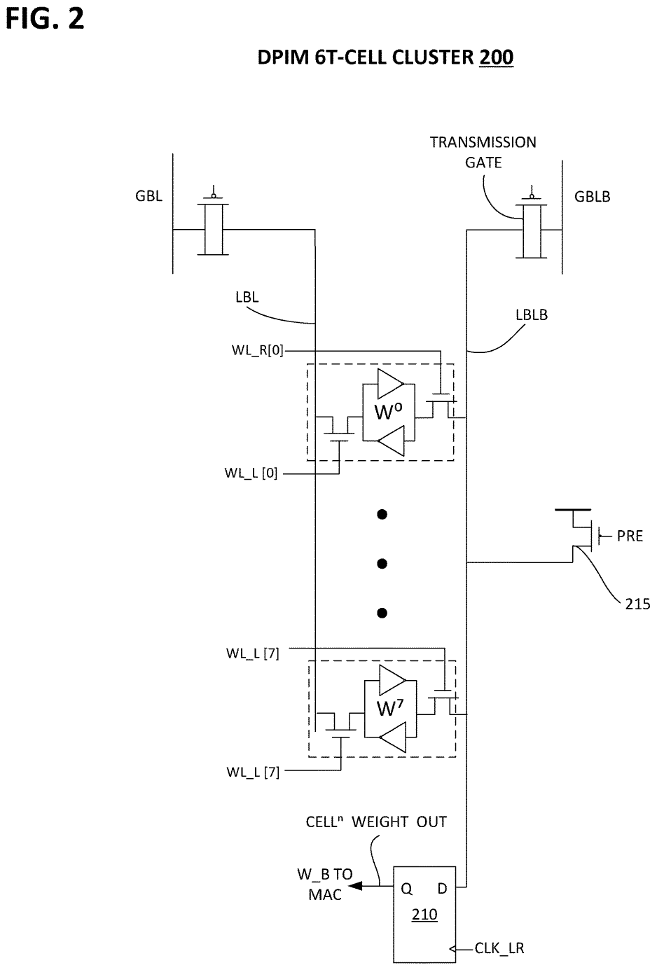

FIG. 2 is a circuit diagram illustrating a 6T memory cell cluster 200. The cluster is comprised of a plurality of memory cells, which in this case is eight cells (cell #0-cell #7). Each cell is comprised of two pass transistors and two pairs of cross-coupled inverters, where each inverter is comprised of one NMOS and one PMOS transistor forming a latch that is controlled by the pass transistors to either receive a bit of weight information or to allow the weight information to be read. Each cell is connected to two word-lines WL_R and WL_L, and each cell is connected to two local bit-lines, LBL and LBLB, that are common to all of the memory cells comprising the cluster. Each word-line is connected to, and controls the operation of, the pass transistors to address each memory cell during a write and a read operation. The memory cell cluster 200 also has a sense device 210 and a pre-charge circuit (transistor) 215 both of which are connected to the LBLB. The device 210 can be a D Flip-Flop that operates to store a voltage level on the LBLB during a read operation, and the pre-charge transistor operates, under control of a PRE signal, to charge the LBLB to Vdd during a pre-charge operation that occurs immediately prior to a read operation.

As will be described later, the flip-flop device 210 is controlled, by a clock signal (CLK_LR), to output one bit of weight information to MAC functionality ahead of a next compute cycle or phase. The flip-flop 210 is controlled by the clock signal to output the bit of weight information in parallel to MAC functionality, and the weight information processed by the MAC is maintained in an accumulator using two's complement power-of-two summation. The weight information read-out into the Flip-Flop can be maintained for an entire compute phase, which can be 4 or 8 clock cycles depending upon whether the input is 4 or 8 bits.

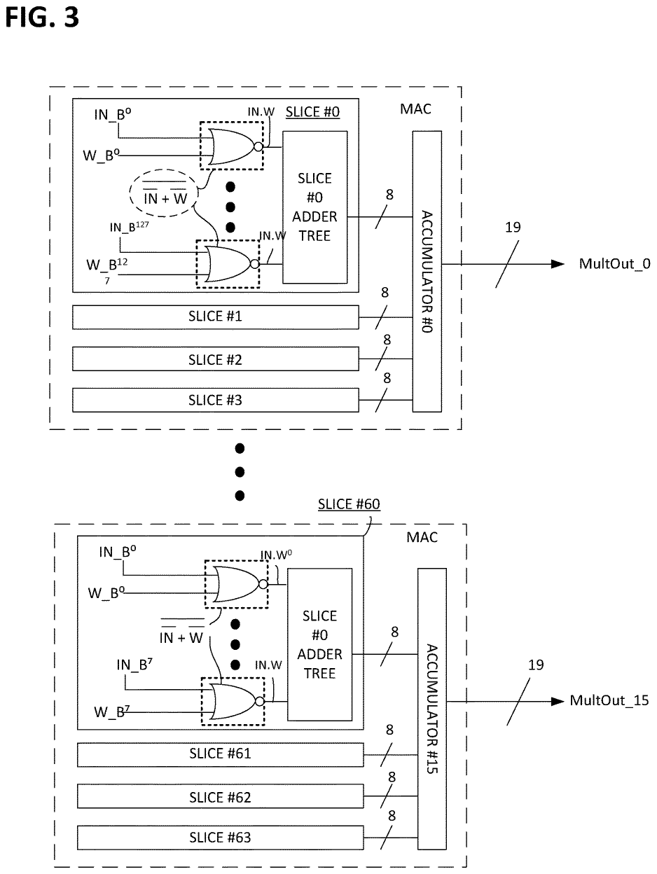

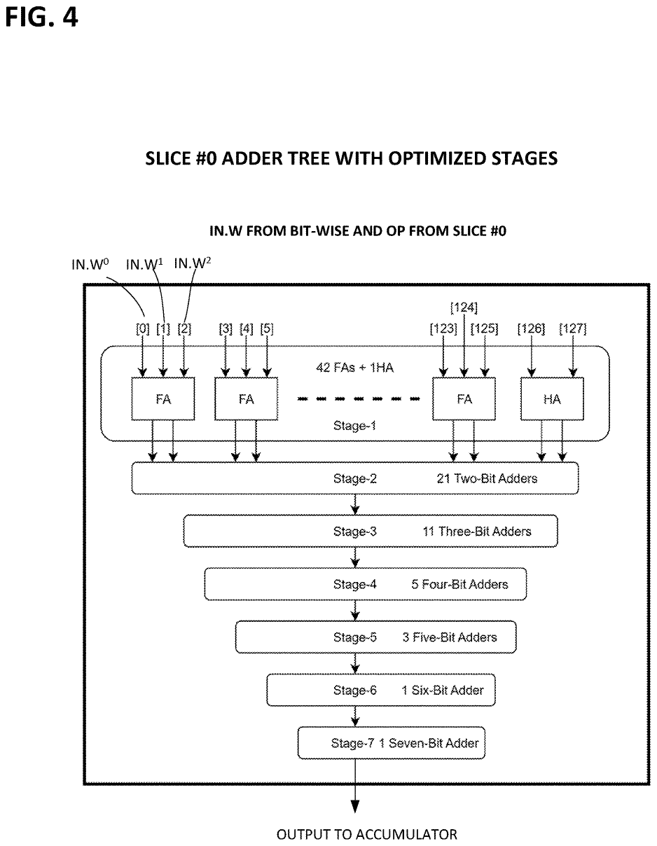

FIG. 3 illustrates the MAC functionality comprising each slice. As described earlier, FIG. 3 also shows that four sequential slices are grouped together to form sixteen groups of slices. The MAC functionality across all sixty-four slices is controlled to operate on weight and input values at the same time to support parallel processing through the macro. As shown with reference to Slice #0 in FIG. 3, a weight value W_B⁰ (maintained by a D Flip-Flop comprising each cluster) and an input vector value IN_B⁰ are operated on by a bit-wise AND operation which results in a IN.W⁰. value. Each cluster in a slice is controlled (by a CLK_LR signal) to send both weight and input information to a MAC function operating in all of the slices comprising the macro during the same clock cycle. The output of each NOR operation (i.e., thirty-two IN. W values for each group of slices) are input to an adder tree comprising slice #0, and the adder tree result is sent to the accumulator #0. As will be described below with reference to FIG. 4, each adder tree is configured to have a first stage comprising 42 full-adders and one half-adder, and each full-adder receives three IN.W values as input. Designing the adder tree in the above manner reduces the number of outputs from sixty-four sum and carry bits to 42 sum and carry bits, resulting in a tree structure operating at its maximum capacity without underflow or overflow, thereby only generating output necessary to support a compute operation.

FIG. 4 is an illustration showing the adder-tree described above having stages that are optimized for maximum bit utilization. As shown in the Figure, the first full adder receives the outputs (IN_0.W_0, IN_1.W_1, IN_2.W_2) from the first three bit-cell clusters comprising slice #0, and the remaining outputs from each cluster in the slice are the inputs to the remaining full-adders and the half-adder. The multiplications propagate through the tree and the output is maintained in the slice #0 accumulator.

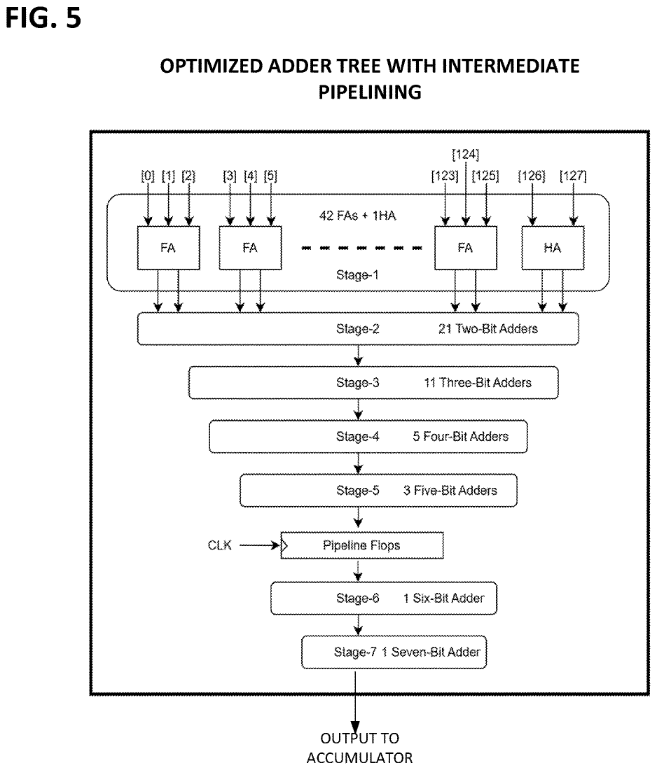

Referring now to FIG. 5 which is an illustration of an optimized adder tree, similar to the one described with reference to FIG. 4, but also comprising an intermediate pipelining arrangement that is implemented in a Flop. As is generally understood, adder trees that are comprised of a long, combination logic path adds delay to a DPIM device. In order to improve throughput in the device, pipelining can be added at a mid-delay point, which in the case of the adder tree in FIG. 5 is after stage 5.

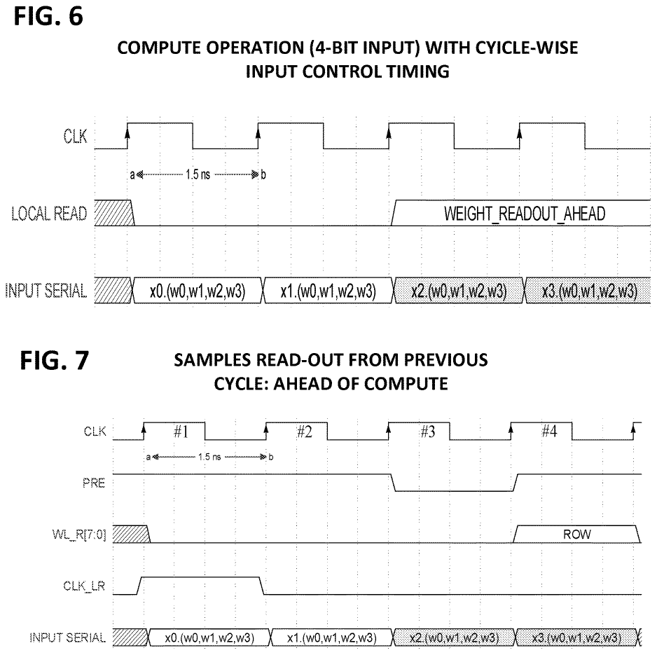

FIG. 6 is a diagram illustrating the timing relationship between reading weight values (ahead of a compute phase) from each of four slices (slices 0 to 3) comprising the DPIM described with reference to FIG. 1. Four, one-hundred twenty-eight-bit input vectors are streamed into respective clusters #0 to #3 in each of the four slices (slice grouping), where MAC operations are performed. Not shown in the figure are MAC operations performed in parallel by the remaining fifteen groups of slices. According to the embodiment illustrated in FIG. 7, weight values can be read-out ahead, and so are immediately available at the start of a subsequent compute phase. After four compute cycles, a 4-bit unsigned input and a 4-bit signed two's compliment weight (both of which are 128 bits in length) are multiplied, resulting in a final 19-bit accumulated output which is shown with reference to FIG. 3.

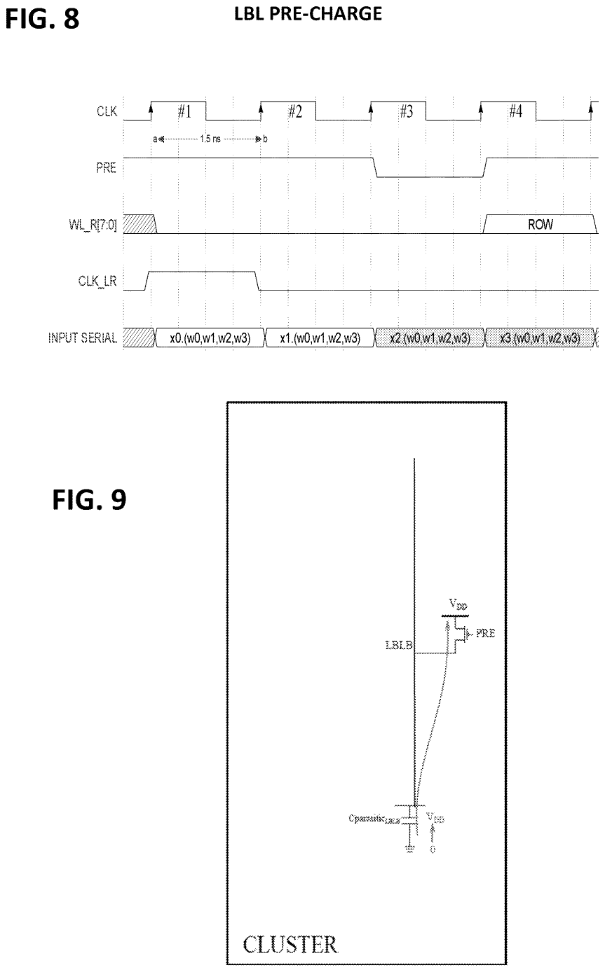

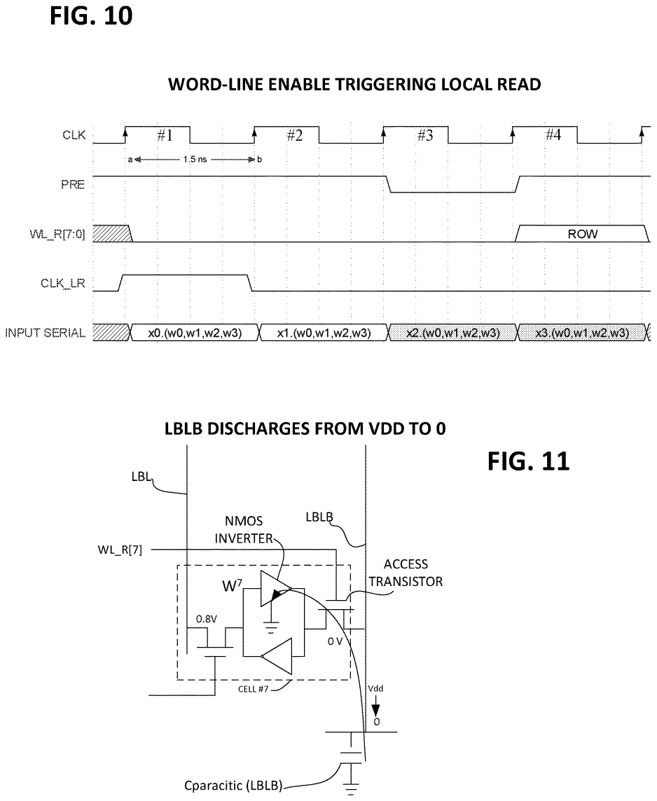

In order to quickly readout weight information maintained in a memory cell, at a first step a local bit-line connected to a memory cell output can be pre-charged to a particular voltage level (see FIG. 9). In a second step, subsequent to the bit-line being pre-charged, weight information can be read from the cell on the local bit-line by the device 210, and this read operation is illustrated here with reference to FIG. 11. This two-step process for reading-out the cell weight is performed in two sequential clock cycles (see timing diagrams in FIGS. 8 and 10 respectively), in which the first cycle is the pre-charge action, and a second cycle is the weight read-out action.

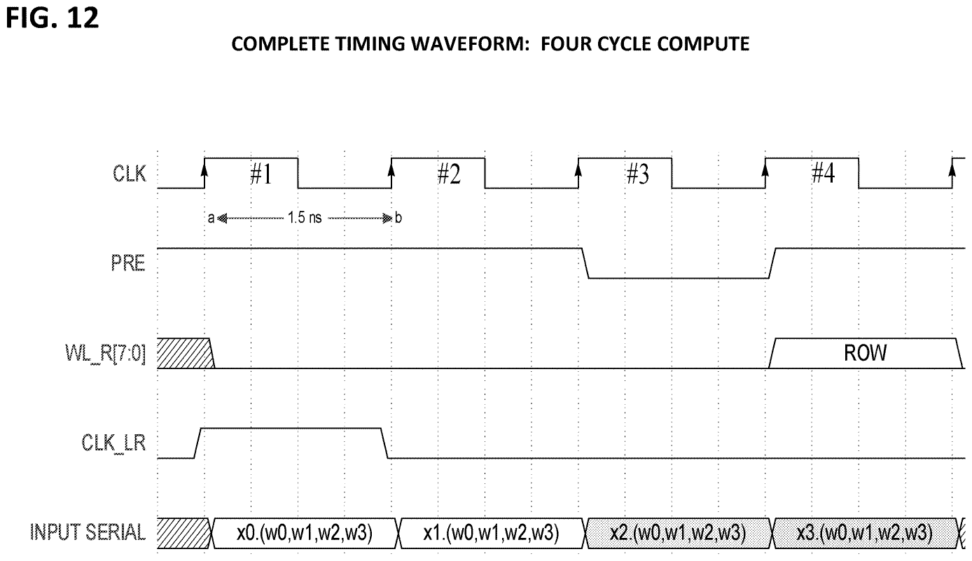

FIG. 12 illustrates a complete timing waveform for a four-cycle compute operation in which a pre-charge and local read operation are shown being completed during cycles 3 and 4 respectively, the CLK-LR signal is shown controlling the local read-ahead operation during the first cycles, and the weights read-out ahead of the compute phase serve as inputs to the MAC operations for each of four slices.

The forgoing description, for purposes of explanation, used specific nomenclature to provide a thorough understanding of the invention. However, it will be apparent to one skilled in the art that specific details are not required in order to practice the invention. Thus, the forgoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications; they thereby enable others skilled in the art to best utilize the invention and various embodiments with various modifications as are suited to the particular use contemplated. It is intended that the following claims and their equivalents define the scope of the invention.

What is claimed is:

1. (canceled)

2. A digital Processing-in-memory (DPIM) macro, comprising:
two or more groups of DPIM slices, wherein each group has the same number of slices, and each slice has a same number of 6T bit-cell clusters, and
a local bit-line, connected to each bit-cell in a cluster, and connected to a temporary storage device (D flip-flop) that is controlled to maintain a weight read out from one of the bit cells in each cluster ahead of a next compute cycle, wherein the weights are read out from each 6T bit-cell cluster comprising the two of more groups of DPIM slices in parallel.

3. The DPIM macro of claim 2, wherein one input vector is applied to the DPIM macro during each cycle of the current compute phase.

4. The DPIM macro of claim 2, wherein each DPIM group has four slices.

5. The DPIM group of claim 4, wherein each slice has one hundred twenty-eight 6T bit-cell clusters.

6. The DPIM macro slice of claim 5, wherein each one of the one hundred twenty-eight 6T bit-cell clusters is comprised of eight 6T bit-cells.

7. The DPIM macro of claim 2, wherein a first stage of an adder-tree comprising each slice has forty-two full-adders and one half-adder.

8. The DPIM adder tree of claim 7, wherein each full-adder receives the output values from three bit-cell clusters, and the half-adder receives the output values from two bit-cell clusters.

9. The DPIM macro of claim 7, wherein each adder-tree has seven stages.

10. The DPIM macro of claim 8, wherein each adder-tree has an intermediary pipeline stage.

11. The DPIM macro of claim 10, wherein the intermediary pipeline is between stages five and six of the adder-tree.

12. A method for performing a DPIM macro compute operation, comprising:
reading out weight information maintained by a selected bit-cell comprising each one of a plurality of 6T bit-cell clusters comprising each DPIM slice prior to a next compute phase;
applying input vector information to the read out weights during a current compute phase; and
the DPIM macro using the stored weight information and an input vector to perform MAC operations in each slice comprising the DPIM in parallel during a current compute phase.

13. The DPIM macro of claim 12, wherein one input vector is applied to the DPIM macro during each cycle of the current compute phase.

14. The method of claim 12, wherein the output from each one of a plurality of groups of four DPIM macro slices is input to a separate accumulator.

15. The method of claim 12, wherein an adder tree has a plurality of stages that are designed for maximum bit utilization.

16. The method of claim 15, wherein the adder tree is comprised of an intermediate pipelining arrangement.

17. The method of claim 16, wherein the intermediate pipelining arrangement is implemented in one or more Flop devices.

18. The method of claim 12, wherein all of the weights maintained in a selected bit-cell comprising each cluster are read-out in parallel during a two-cycle pre-charge and local read operation during the last two cycles of the current compute phase.

19. The method of claim 18, wherein the pre-charge operation is performed during a first one of the two cycles, and the local read operation is performed during a second one of the two cycles.
